(19) United States
(12) Patent Application Publication
(10) Pub. No.: US 2007/0159455 A1
(43) Pub. Date: Jul. 12, 2007

(54) Image-sensing game-controlling device

(75) Inventor: Jui-Hsiang Lin, Taipei (TW)

Correspondence Address: TROXELL LAW OFFICE PLLC, Suite 1404, 5205 Leesburg Pike, Falls Church, VA, 22041, US

(73) Assignee: Ronmee Industrial Corporation

(21) Appl. No.: 11/326,499

(22) Filed: Jan. 6, 2006

(51) Int. Cl. G09G 5/00

(52) U.S. Cl. 345/156

(57) ABSTRACT

An image-sensing game-controlling device comprises a detector and a controller, wherein the detector comprises a X-axial digital camera, a Y-axial digital camera, and a Z-axial digital camera, and the controller comprises an image integrator, an image comparator, and a motion database. Besides, the detector is connected to the controller for transmitting image signals and the controller is connected to a game machine for transmitting control signals. When the player makes motions, the digital cameras capture the motion images continuously. Thereafter, the captured motion images are temporarily stored in the image integrator and updated instantaneously for being compared with the motion data stored in the motion database. Thereafter, the comparison results are transmitted to the image integrator so as to output corresponding motion signals to the game machine for enabling the virtual game role to make the corresponding motions.

### FIELD OF THE INVENTION

The present invention relates to a game-controlling device, and more particularly to an image-sensing game-controlling device that makes the virtual role's motions consistent with that of the player such that the player can make random motions within a predetermined region directly for increasing the virtual game's amusement and reality instead of using conventional joystick, controller, mouse, or other input apparatuses.

### BACKGROUND OF THE INVENTION

Most existing game machines are controlled by input apparatuses such as joystick, controller, mouse, or keyboard so as to control the motions of the virtual game role or article. In order to provide the player with more reality and live feeling, many conventional products that utilize the virtual-reality technology were disclosed. For example, in 1968, at the university of Utah, the first head mounted display (HMD) was built by Ivan Sutherland, the father of computer graphics, and the data glove was developed by VPL Research in 1985. Up to now, these products, which were formed by advanced designs, are still utilized to enable the player to experience the virtual reality.

However, the player cannot experience the virtual reality in the absence of input apparatuses, which restrain the player, so the player cannot make motions freely. Therefore, only little interaction is formed between the virtual role and the player. Consequently, the player is provided with no sense of participation, and the player cannot make motions and perform himself heartily.

### SUMMARY OF THE INVENTION

In view of the drawbacks and the deficiencies of the conventional game-controlling device, the present inventor makes diligent study in improvement and innovation in accordance with his many years experience in this art, thereby providing an image-sensing game-controlling device with more industrial utilization.

It is a major object of the present invention to provide an direct, instantaneous, and interactive game-controlling device for controlling the virtual game role in accordance with the player's free will and intention, wherein a detector is mounted for capturing the player's motions automatically and these motions are responded by the game-controlling device instantaneously such that real-time commands can be generated without using any input apparatuses or contacting any conventional game-controlling device. As a result, the virtual role's motions are consistent with that of the player and the limitation caused by the input apparatuses is reduced, whereby the player can control the virtual role or article freely, instantaneously by making motions. Consequently, more reality is provided for the player to enable him to really take part in the simulated virtual environment.

### BRIEF DESCRIPTION OF THE DRAWINGS

FIG. 1 is a schematic view showing a first preferred embodiment of the present invention.

FIG. 2 is a schematic view showing the detector of the present invention.

FIG. 3 is a block diagram of the first preferred embodiment of the present invention.

FIG. 4 is a schematic view showing a second preferred embodiment of the present invention.

FIG. 5 is a schematic view showing the detector of the second preferred embodiment of the present invention.

FIG. 6 is a block diagram of the second preferred embodiment of the present invention.

### DETAILED DESCRIPTION OF THE PREFERRED EMBODIMENT

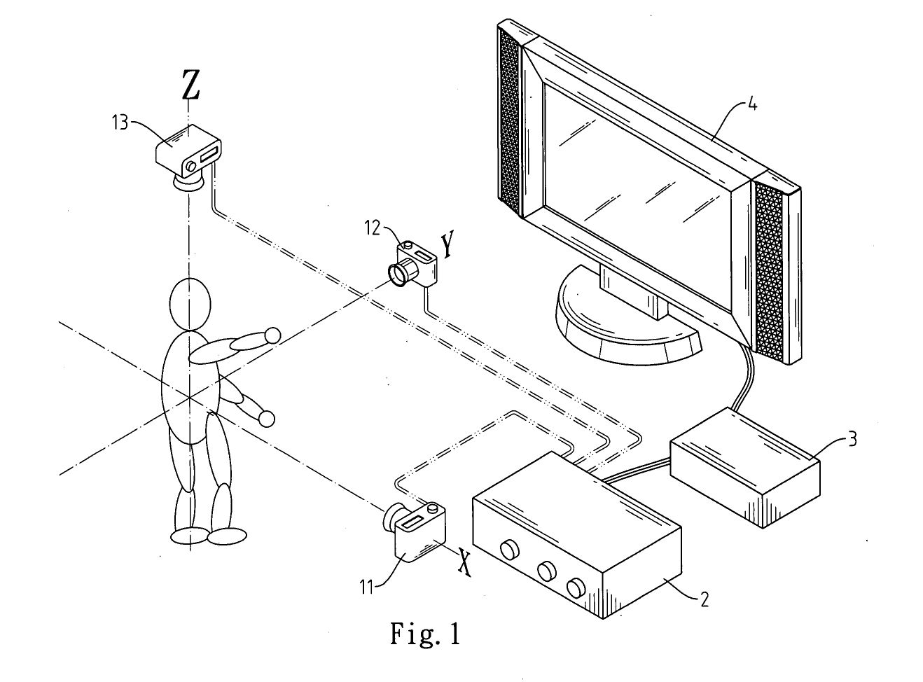

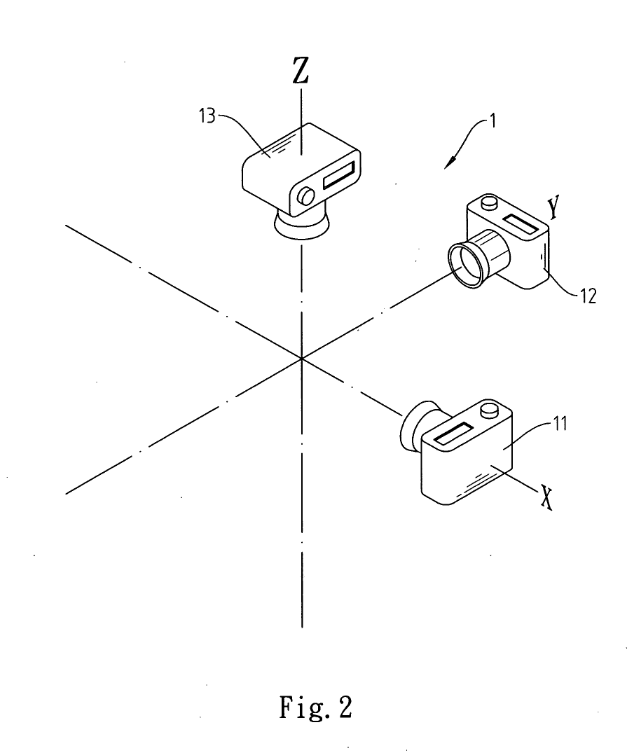

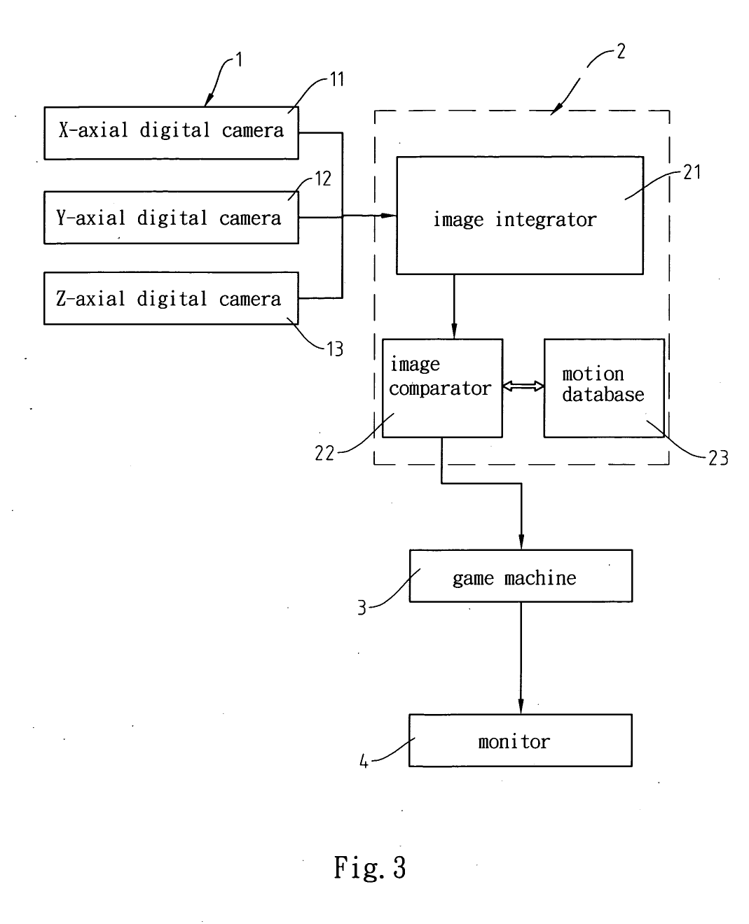

Referring to FIG. 1 through FIG. 3, an image-sensing game-controlling device of the present invention comprises a detector 1 and a controller 2, wherein the detector 1 further comprises a X-axial digital camera 11, a Y-axial digital camera 12, and a Z-axial digital camera 13 mounted on X, Y, and Z axes, respectively, for capturing X-, Y-, and Z-axial images, as shown in FIG. 2. Thereafter, the image signals are then transmitted to the controller 2, which is connected to the detector 1. As shown in FIG. 3, the controller 2 comprises an image integrator 21, an image comparator 22, and a motion database 23. Besides, the controller 2 is connected to a game machine 3 for transmitting control signals, wherein the image integrator 21 is a memory for temporarily storing the image signals captured by the detector 1. Besides, the motion database 23 is also a memory for storing data of images and parameters of game status. In addition, the motion database 23 is connected to the image comparator 22, wherein the image comparator 22 is a central processing unit (CPU) with operating and comparing functions.

As shown in FIG. 1, the player is stood within a predetermined region, so the X-axial digital camera 11, the Y-axial digital camera 12, and the Z-axial digital camera 13 are mounted on X, Y and Z axes, respectively, for capturing X-, Y-, and Z-axial images. As a result, the player can freely make motions such as shifting, hitting, kicking, or jumping within this predetermined region. In addition, when the player shifts his positions and changes his speed, the digital cameras can capture the motion images continuously. Thereafter, the captured motion images are temporarily stored in the image integrator 21 and updated instantaneously. In accordance with the player's position and his different speed for changing motions, the above-mentioned motion images are compared with the motion data stored in the motion database 23 to compare the differences and the characteristics continuously by using the image comparator 22. Thereafter, the comparison results are transmitted to the image integrator 21 so as to output corresponding signals to the game machine 3 for enabling the virtual game role to make the corresponding motions and showing these corresponding motions by a monitor 4.

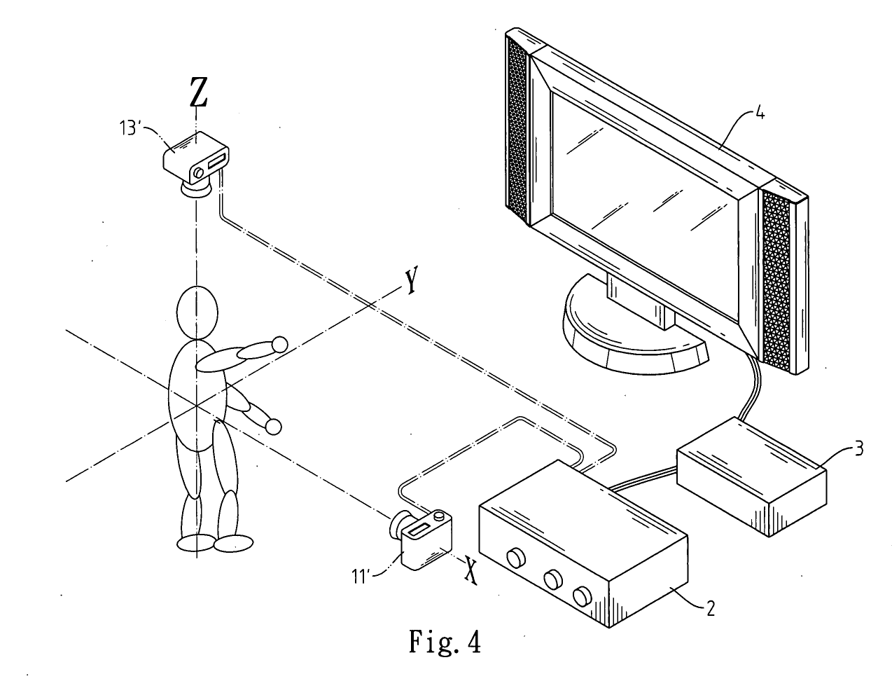

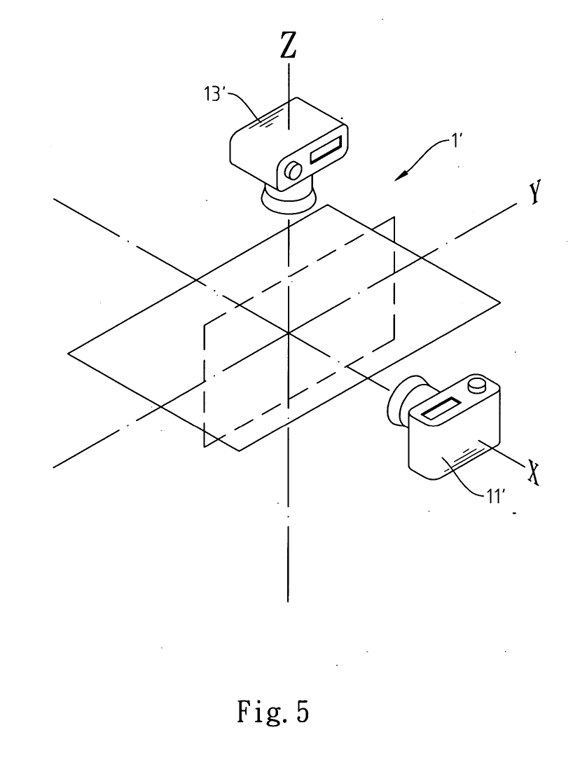

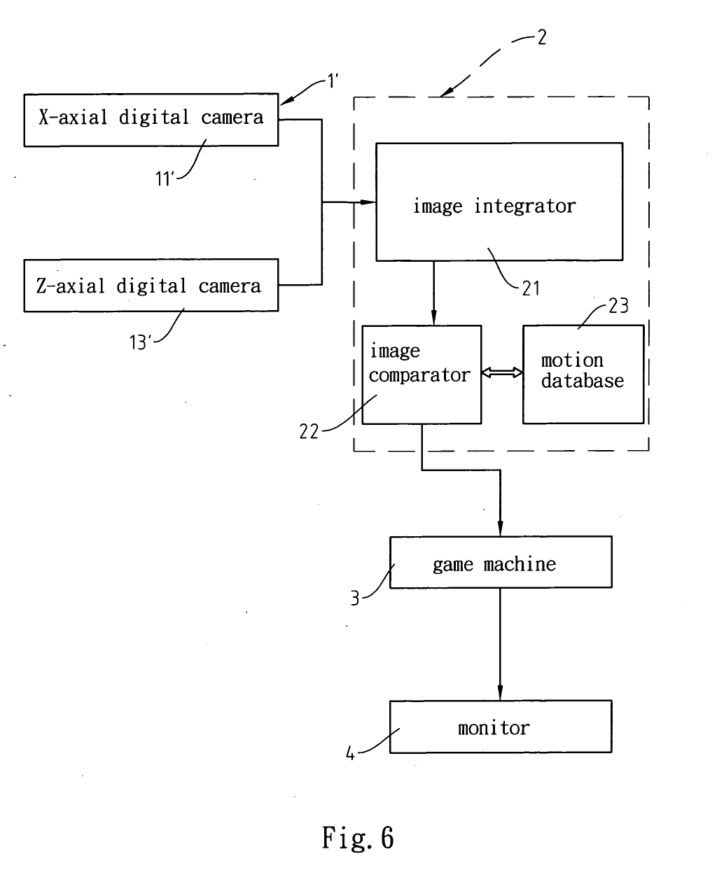

Referring to FIG. 4 through FIG. 6, another preferred embodiment is shown, wherein two digital cameras are utilized. The detector 1′ comprises a X-axial digital camera 11′ and a Z-axial digital camera 13′ for capturing YZ and XY planar images, thereby capturing the player's motions fully for forming three-dimensional images. Because most images can be captured by the X-axial digital camera 11′, the Z-axial digital camera 13′ is designed for further capturing the images and for balancing off the insufficiency of the X-axial digital camera 11′. In addition, the Z-axial digital camera 13′ can differentiate the leftward and rightward motions of the player's hands and feet particularly when the X-axial digital camera 11′ is located perpendicular to the player.

Moreover, the monitor 4 can be a special helmet-type monitor to isolate the player from the outside such that the player can get more clearly live feeling via a small-sized screen in front of the player's eyes so as to provide the virtual game with more human-machine interaction. As a result, the conventional joystick, controller, mouse, or other input apparatuses can be replaced by the image-sensing game-controlling device of the present invention for increasing the virtual game's amusement and reality.

To sum up, the present invention is characterized in that the player's motion images are captured automatically by the detector to generate the corresponding commands for controlling the virtual role that represents the player. As a result, the conventional joystick, controller, mouse, or other input apparatuses can be replaced by the image-sensing game-controlling device of the present invention for increasing the virtual game's amusement and reality. The body's motion is the most natural, dexterous expression way so it is more suitable for the player in comparison with conventional keyboard or mouse. Therefore, the present invention makes the player more comfortable and unrestricted. It is additionally mentioned that the present invention does not intend to claim the scope about the operation of the image comparator since it is performed by software.

What the invention claimed is:

1. An image-sensing game-controlling device comprising:
a detector comprising a X-axial digital camera, a Y-axial digital camera, and a Z-axial digital camera; and
a controller comprising an image integrator, an image comparator, and a motion database, wherein the detector is connected to the controller for transmitting image signals and the controller is connected to a game machine for transmitting control signals.

2. The image-sensing game-controlling device of claim 1, wherein the image integrator is a memory.

3. The image-sensing game-controlling device of claim 1, wherein the motion database is a memory.

4. The image-sensing game-controlling device of claim 1, wherein the image comparator is a central processing unit.

5. An image-sensing game-controlling device comprising:
a detector comprising a X-axial digital camera and a Z-axial digital camera; and
a controller comprising an image integrator, an image comparator, and a motion database, wherein the detector is connected to the controller for transmitting image signals and the controller is connected to a game machine for transmitting control signals.

6. The image-sensing game-controlling device of claim 5, wherein the image integrator is a memory.

7. The image-sensing game-controlling device of claim 5, wherein the motion database is a memory.

8. The image-sensing game-controlling device of claim 5, wherein the image comparator is a central processing unit.
